(19) United States
(12) Patent Application Publication
(10) Pub. No.: US 2025/0243568 A1
(43) Pub. Date: Jul. 31, 2025

(54) LOW-COST HIGH-PERFORMANCE REFRACTORY HIGH ENTROPY ALLOYS FOR GAS TURBINE BLADE APPLICATIONS ABOVE 1300 CELSIUS

(71) Applicant: United States Department of Energy, Washington, DC (US)

(72) Inventors: Michael C. Gao, Albany, OR (US); David E. Alman, Corvallis, OR (US); Michael Kirka, Knoxville, TN (US); Michael Widom, Pittsburgh, PA (US); Saket Thapliyal, Knoxville, TN (US)

(21) Appl. No.: 18/426,472

(22) Filed: Jan. 30, 2024

(51) Int. Cl. C22C 32/00; C22C 1/10

(52) U.S. Cl. CPC C22C 32/0052; C22C 1/10

(57) ABSTRACT

A high-performance refractory high entropy alloy having Nb≥30 at %, Ta≤20 at %, Ti≤30 at %., Mo≤30 at %, Hf≤5 at %, Zr≤5 at %, C≤5 at %, V≤20 at %, Al between approximately 0 and approximately 10 at %, Cr between approximately 0 and approximately 10 at %, W≤10 at %, B≤1 at %, and Y≤1 at % and methods for making a high-performance refractory high entropy alloy. The alloy is precipitation hardened such that MC carbides precipitate in the alloy when annealed.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory.

### FIELD OF THE INVENTION

Embodiments relate to high-performance refractory high entropy alloys for gas turbine blade applications above 1300° C. More specifically, embodiments relate to refractory high entropy alloys including the elements Nb, Mo, Ta, Ti, Zr, Hf, V, Cr, Al, C and other trace elements, wherein said alloys are designed to strengthen during the annealing process as a result of MC carbides precipitating into the solid solution comprising said alloys.

### BACKGROUND

Developing ultrahigh-temperature alloys beyond Ni-based superalloys has been a long and difficult process. For example, Nb alloys, other refractory alloys, aluminides, and silicides have been explored, but to date no breakthrough has been made in bringing them to the commercial application. The main obstacle lies in achieving balanced properties, such as optimizing room temperature (RT) ductility, RT fracture toughness, high-temperature creep, fatigue, thermal stability, and oxidation resistance while being lightweight and low cost.

The high entropy alloys (HEAs) concept opens a largely unexplored compositional space compared to traditional single-principal-element alloys, and thus has promise for next-generation ultra-high temperature turbine material. However, technical challenges to overcome remain. First, the vast majority Refractory High Entropy Alloys (RHEAs) have reported poor room temperature (RT) ductility, with almost no information on tensile ductility available, with the exceptions of a few reports on the Hf—Nb—Ta—Ti—Zr system and its derivatives (Hf_{0.5}Nb_{0.5}Ta_{0.5}Ti_{1.5}Zr, HfNbTiZr, Ta_{0.4·0.6}HfTiZr) and NbTaTiV. However, alloys based on the Hf—Nb—Ta—Ti—Zr system have poor high-temperature strength.

Second, RHEAs, like refractory metals, have very poor oxidation resistance, and attempts to add Al, Cr or Si to promote protective oxide surface scales, results in the formation of brittle intermetallic phases, adversely affecting ductility and toughness. Lack of efficient and reliable design methodologies is the main obstacle to the discovery of high-performance refractory alloys. Another challenge is the difficulty in processing these alloys with very high melting points and susceptibility to oxidation.

A need exists in the art for a high-performance refractory high entropy alloy that overcomes the disadvantages of the prior art.

### SUMMARY

Embodiments of the invention provide high-performance refractory high entropy alloys having superior qualities to prior art alloys, the present alloys suitable for use in turbines, turbine blades, and other high temperature applications. Embodiments feature these alloys where MC carbides and various oxides precipitate into the structure of said alloy when the alloys are taken from their as-cast to annealed states.

The invention provides a high-performance refractory high entropy alloy comprising: Nb≤30 at %, Ta≤20 at %, Ti≤30 at %, Mo≤30 at %, Hf≤5 at %, Zr≤5 at %, C≤5 at %, V≤20 at %, Al between approximately 0 and approximately 10 at %, Cr between approximately 0 and approximately 10 at %, W≤10 at %, B≤1 at %, and Y≤1 at %.

The invention also provides a method for producing a high-performance refractory entropy alloy comprising: forming an as-cast alloy comprising Nb≥30 at %, Ta≤20 at %, Ti≤30 at %, Mo≤30 at %, Hf≤5 at %, Zr≤5 at %, C≤5 at %, V≤20 at %, Al between approximately 0 and approximately 10 at %, Cr between approximately 0 and approximately 10 at %, W≤10 at %, B≤1 at %, and Y≤1 at %; annealing the as-cast alloy to form a high-performance refractory high entropy alloy.

### BRIEF DESCRIPTION OF THE DRAWINGS

The invention together with the above and other objects and advantages will be best understood from the following detailed description of the preferred embodiment of the invention shown in the accompanying drawings, wherein:

FIGS. 1A-1L are tables listing the composition of exemplary high-performance refractory high entropy alloys and properties thereof, in accordance with the features of the present invention;

FIG. 2 is a flowchart depicting a method to make high-performance refractory high entropy alloys, in accordance with the features of the present invention;

FIG. 3A is a graph of x-ray diffraction (XRD) data for as-cast samples of exemplary high-performance refractory high entropy alloys, in accordance with the features of the present invention;

FIG. 3B is a graph of XRD data for annealed samples of exemplary high-performance refractory high entropy alloys, in accordance with the features of the present invention;

FIG. 4A is a scanning electron microscopy (SEM) image showing the microstructure of an exemplary high-performance refractory high entropy alloy as-cast, in accordance with the features of the present invention;

FIG. 4B is a SEM secondary image showing the microstructure of an exemplary high-performance refractory high entropy alloy as-cast, in accordance with the features of the present invention;

FIG. 4C is a transmission electron microscopy (TEM) image showing the microstructure of an exemplary high-performance refractory high entropy alloy as-cast, in accordance with the features of the present invention;

FIG. 4D is a TEM selected area electron diffraction (SAED) pattern image showing that the microstructure of an exemplary high-performance refractory high entropy alloy as-cast has a body centered cubic (BCC) crystal structure, in accordance with the features of the present invention;

FIG. 5A is a SEM image showing the microstructure of an exemplary high-performance refractory high entropy alloy after annealing in a flowing argon environment, in accordance with the features of the present invention;

FIG. 5B is a SEM image showing the microstructure of an exemplary high-performance refractory high entropy alloy after annealing, in accordance with the features of the present invention;

FIG. 5C is a SEM image showing the microstructure of an exemplary high-performance refractory high entropy alloy after annealing, in accordance with the features of the present invention;

FIGS. 5D and 5E are SEM phase composition analysis plots of indicated features shown in FIG. 5C, in accordance with features of the present invention;

FIG. 5F is a SEM image showing the microstructure of an exemplary high-performance refractory high entropy alloy after annealing, in accordance with the features of the present invention;

FIG. 5G is a SEM image showing a magnified feature of FIG. 5F, that feature shown in box G of FIG. 5F, in accordance with the features of the present invention;

FIG. 5H is a SEM image showing a magnified feature of FIG. 5F, that feature shown in box H of FIG. 5F, in accordance with the features of the present invention;

FIGS. 5I and 5J are SEM phase composition analysis plots of indicated features shown in FIG. 5H, with FIG. 5I showing a SEM phase composition analysis plot of feature I shown in FIG. 5H, and FIG. 5J showing a SEM phase composition analysis plot of feature J shown in FIG. 5H, in accordance with features of the present invention;

FIG. 5K is a SEM image showing a magnified feature of FIG. 5F, that feature shown in box K of FIG. 5F, in accordance with the features of the present invention;

FIG. 5L provides a SEM phase composition analysis plot of feature L shown in FIG. 5K, in accordance with features of the present invention;

FIG. 5M is a SEM image showing a magnified feature of FIG. 5F, that feature shown in box M of FIG. 5F, in accordance with the features of the present invention;

FIGS. 5N and 5O are SEM phase composition analysis plots of indicated features shown in FIG. 5M, with FIG. 5N showing a SEM phase composition analysis plot of feature N shown in FIG. 5M, and FIG. 5O showing a SEM phase composition analysis plot of feature O shown in FIG. 5M, in accordance with features of the present invention;

FIG. 6A is a TEM image showing the microstructure of an exemplary high-performance refractory high entropy alloy after annealing, in accordance with the features of the present invention;

FIG. 6B is a STEM image showing the microstructure of an exemplary high-performance refractory high entropy alloy after annealing, in accordance with the features of the present invention;

FIG. 6C is TEM selected area electron diffraction pattern data from point A-matrix BCC phase in FIG. 6A, confirming its BCC crystal structure, in accordance with the features of the present invention;

FIG. 6D is TEM selected area electron diffraction pattern data from point B-MC carbide in FIG. 6A, confirming its FCC crystal structure, in accordance with the features of the present invention;

FIG. 6E are elemental distribution plots of the portion of the exemplary annealed alloy shown in FIG. 6B, in accordance with the features of the present invention;

FIG. 7 is a calculated phase diagram for an exemplary high-performance refractory high entropy alloy, RHEA 18, in accordance with the features of the present invention;

FIG. 8 are SEM backscatter electron (BSE) micrographs of as-cast ingots of RHEA 9, 10, 13, 14, 15, and 16, in accordance with the features of the present invention;

FIG. 9 shows SEM x-ray compositional mapping results for an as-cast ingot of RHEA 18, in accordance with the features of the present invention;

FIG. 10 shows RT compression testing results for as-cast ingots of RHEA 9, 10, 13, 14, 15, 16, 17, and 18, in accordance with the features of the present invention;

FIGS. 11A-C show backscattered electron (BSE) micrographs of an annealed sample of RHEA 18, with FIG. 11A showing the microstructure near the surface of the sample, FIG. 11B showing the microstructure of a region of the sample below the surface, and FIG. 11C showing the microstructure near the center of the sample, in accordance with the features of the present invention;

FIGS. 12A-E are BSE micrographs of samples of RHEAs 18 (FIG. 12A), 17 (FIG. 12B), 16 (FIG. 12C), 14 (FIG. 12D), and 1 (FIG. 12E) annealed for 100 hours at 1300° C., in accordance with the features of the present invention;

FIG. 13 is graph showing a comparison of RT compression engineering yield stress test data for samples of exemplary high-performance refractory high entropy alloys before and after annealing, in accordance with the features of the present invention;

FIGS. 14A and 14B show the microstructure of an as-cast sample of RHEA 19, with FIG. 14A showing a BSE micrograph of a cross-section of RHEA 19 and FIG. 14B showing a SE micrograph of a cross section of RHEA 19, in accordance with the features of the present invention;

FIGS. 15A-D show BSE micrographs of a cross-section of as-cast RHEA 26 at various magnification, in accordance with the features of the present invention;

FIG. 16 shows SEM x-ray wavelength dispersion compositional mapping results for an as-cast ingot of RHEA 26, in accordance with the features of the present invention;

FIG. 17 is a plot of RT compression test data for RHEAs 19-26, in accordance with the features of the present invention;

FIG. 18 is a plot of XRD data for as-cast samples of RHEAs 27-30, in accordance with the features of the present invention;

FIG. 19 shows BSE micrographs of as-cast ingots of RHEAs 27-30, in accordance with the features of the present invention;

FIG. 20 shows SEM x-ray wavelength dispersion composition map of an as-cast sample of RHEA 27;

FIG. 21A shows compression testing data for ingots of as-cast RHEAs 27-30 at room temperature, in accordance with the features of the present invention;

FIG. 21B shows compression testing data for ingots of as-cast RHEAs 27-30 at 1300° C., in accordance with the features of the present invention;

FIG. 22 shows compression testing data for as-cast ingots of select RHEAs at 1300° C., in accordance with the features of the present invention;

FIG. 23 shows compression testing data at 1300° C. for annealed samples of RHEAs 21, 22, and 24, in accordance with the features of the present invention;

FIGS. 24A and 24B show XRD data for select RHEAs in as-cast and annealed states, with FIG. 24A showing XRD data for as-cast samples and FIG. 24B showing XRD data for annealed samples, in accordance with the features of the present invention;

FIG. 25 shows XRD data for select RHEAs after annealing, with FIG. 18 showing the XRD data for those same RHEAs in an as-cast condition, in accordance with the features of the present invention;

FIG. 26 shows SEM BSE micrographs of as-cast samples RHEAs 32 and 35, in accordance with the features of the present invention;

FIG. 27 shows a graph of predicted yield stress at 1300° C. for the invented alloys, in accordance with the features of the present invention;

FIGS. 28A-C show SEM BSE micrographs of varying magnification of a sample of RHEA 15 made using L-DED, in accordance with the features of the present invention;

FIGS. 29A-C show SEM BSE micrographs of varying magnification of a sample of RHEA 15 made using EBM, in accordance with the features of the present invention; and

FIG. 30 shows compositional mapping results for an as-cast ingot of RHEA 15 generated using EBM, in accordance with the features of the present invention;

### DETAILED DESCRIPTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

As used herein, “MC carbide” means a carbide formed with any non-carbon constituent of the invented alloy described herein, the alloy in its as-cast or annealed state. In embodiments, MC carbide encompasses non-oxidized carbides, partially oxidized carbides, oxidized carbides, and combinations thereof.

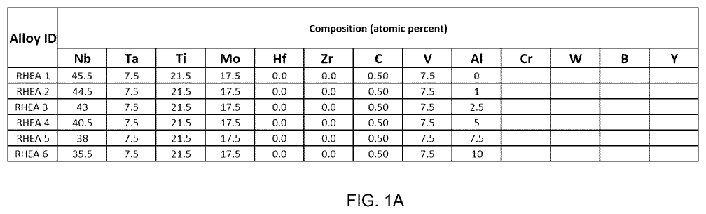

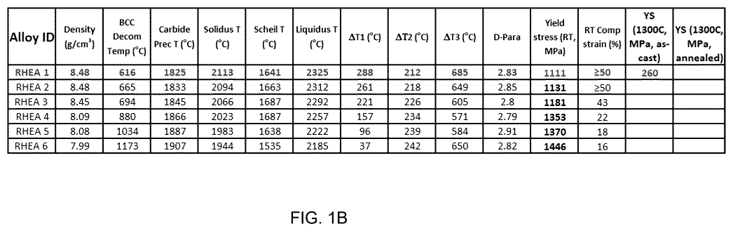

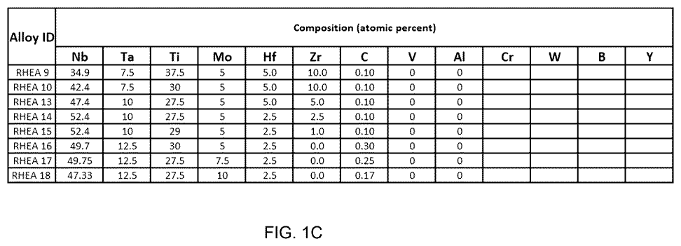

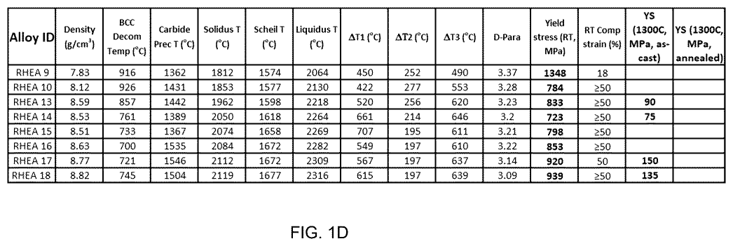

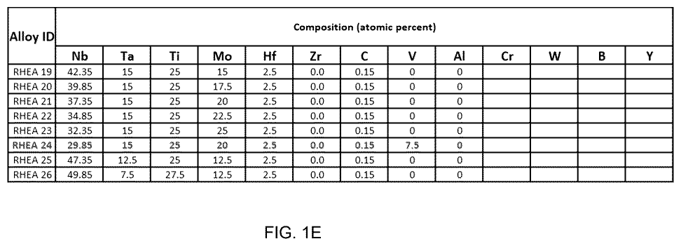

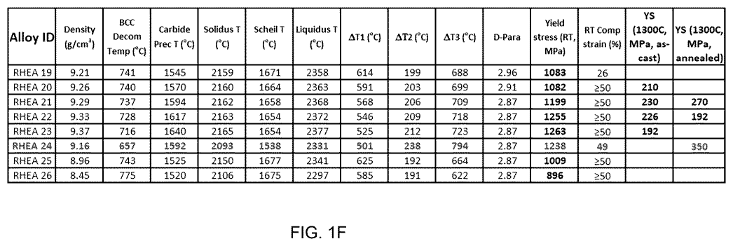

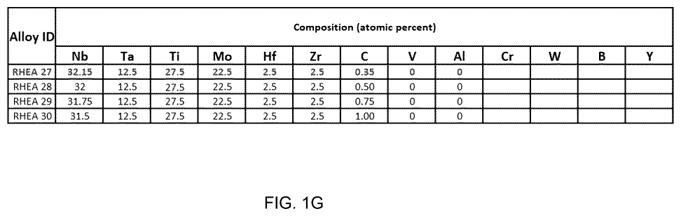

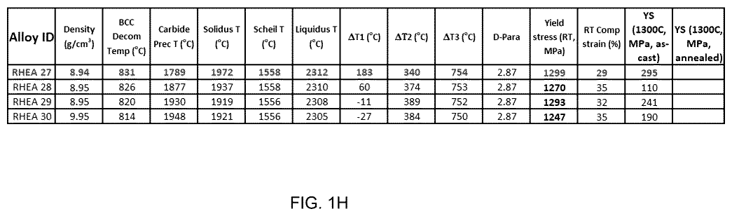

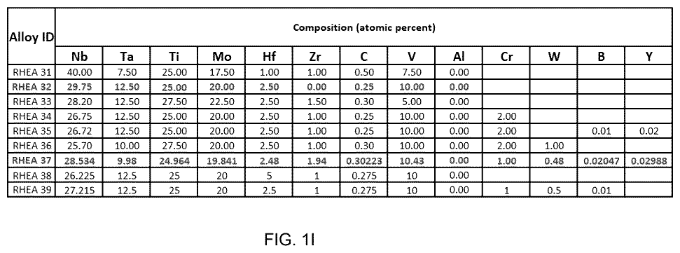

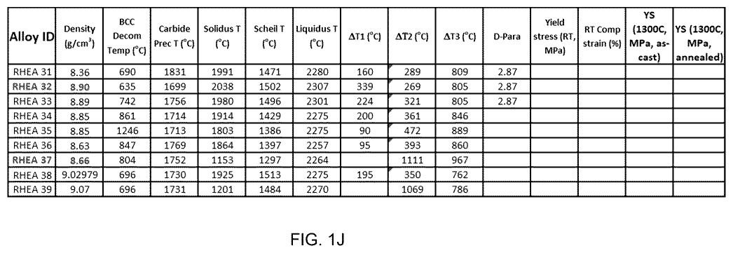

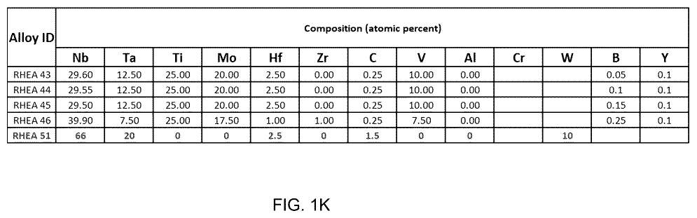

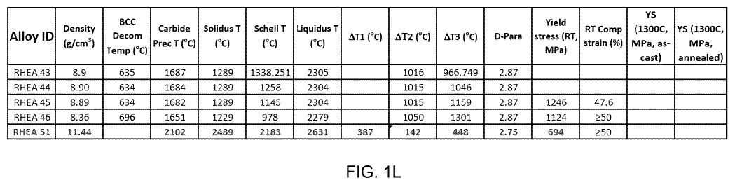

As used herein, “RHEA” means Refractory High Entropy Alloy. Further, RHEA used with a number, i.e. RHEA 46” refers to an exemplary RHEA designed and tested as described herein, with the compositions of said exemplary RHEAs shown in FIGS. 1A, 1C, 1E, 1G, 1I, and 1K.

### Alloy Detail

An embodiment of the invention provides a high-performance refractory high entropy alloy comprising the elements Nb, Mo, Ta, Ti, Zr, Hf, V, Cr, Al, C and other trace elements. Generally, such an alloy comprises the elements Nb≥30 at %, Ta≤20 at %, Ti≤30 at %., Mo≤30 at %, Hf≤5 at %, Zr≤5 at %, C≤5 at %, V≤20 at %, Al between approximately 0 and approximately 10 at %, Cr between approximately 0 and approximately 10 at %, W≤10 at %, B≤1 at %, and Y≤1 at %. In some embodiments, the invented alloy comprises the elements Nb between approximately 30 at % and approximately 70 at %, Ta between approximately 2.5 at % and approximately 20 at %, Ti between approximately 0 at % and approximately 30 at %, Mo between approximately 5 at % and approximately 30 at %, Hf between approximately 0 at % to approximately 5 at %, Zr between approximately 0 at % and approximately 5 at %, C between approximately 0.1 a % and approximately 5 at %, V between approximately 0 at % and approximately 20 at %, Al between approximately 0 at % and approximately 10 at %, Cr between approximately 0 at % and approximately 10 at %, W between approximately 0 at % and approximately 10 at %, B between approximately 0 at % and approximately 1 at %, and Y between approximately 0 at % and approximately 1 at %. The invented alloys, in their finalized, annealed state comprise ductile high entropy solid solution matrices comprising and strengthened by high entropy metal carbides (MC) and, in some embodiments, high entropy metal oxides. As a result of the macro and microstructure of the alloys, said alloys possess superior properties to prior art alloys such as density, ductility, solidus temperature, yield stress, and tensile elongation. FIGS. 1A-1L provide exemplary elemental compositions and properties of embodiments of the invented alloys, each embodiment abbreviated with RHEA for “refractory high entropy alloy” and a number.

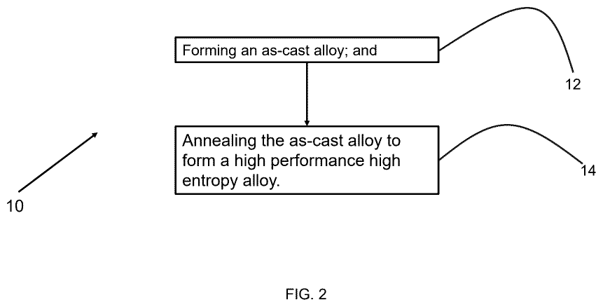

The invention also provides a method 10 for making high-performance refractory high entropy alloys (RHEAs), the method 10 depicted in FIG. 2. The method 10 begins by forming an as-cast alloy 12. After the as-cast alloy is formed, the method 10 continues by annealing the as-cast alloy to form a high-performance refractory high entropy alloy, wherein the high-performance refractory high entropy alloy is precipitation hardened.

As described above and shown in FIG. 2, the invented method to make RHEAs begins by forming an as-cast alloy 12. In an embodiment, the forming an as-cast alloy step 12 comprises creating a mixture comprising the elements to form the as-cast alloy, wherein the mixture comprises said elements in the desired atomic % (at %). A person having ordinary skill in the art will readily ascertain that any method to generate an alloy from its individual constituents can be used in the forming step 12. In an embodiment, the forming step 12 is completed using arc melting, additive manufacturing (AM), directed energy deposition (DED), and combinations thereof in order to achieve crack-free RHEAs with desired morphology, and desired micro and macro structures.

After the as-cast alloy is formed in the forming step 12, the method continues by annealing the as-cast alloy to form a high-performance refractory high entropy alloy 14. In an embodiment, annealing the as-cast alloy comprises heating the as-cast alloy at an annealing temperature for an annealing time followed by allowing the heated alloy to return to room temperature. During the annealing step 14, MC carbide precipitates form within the alloy, these MC carbide precipitates forming along grain boundaries of the alloy and in interdendritic regions of the alloy. In an embodiment, the annealing temperature is any temperature suitable to provide the micro and macro structure of the high-performance refractory high entropy alloys and the resulting properties described herein. In an embodiment, the annealing temperature is between approximately 800° C. and approximately 2000° C., preferably between approximately 1000° C. and approximately 1800° C., and typically between approximately 1200° C. and approximately 1600° C. In an embodiment, the annealing time is between approximately 24 hours and approximately 100 hours at 1300° C., preferably between approximately 24 hours and approximately 72 hours at 1200° C.-1400° C. One having ordinary skill in the art will readily discern that annealing times and temperatures can be adjusted according to the composition of the alloy being annealed. In an embodiment, the annealing time is sensitive to the annealing temperature. In an embodiment, a higher annealing temperature typically requires less annealing time and vice versa. In an embodiment, the annealing temperature and annealing time are also sensitive to the alloy compositions. A higher solidus temperature typically requires a higher annealing temperature and/or longer annealing time.

In an embodiment, the annealing temperature is below the MC carbide threshold precipitation temperature for the alloy being annealed, above which MC carbide precipitation will not occur. In an embodiment, the annealing temperature is high enough to allow fast solid-state diffusion.

A salient feature of the invention is the structure of the invented alloys, and the change in the structure of the invented alloys enabled by the composition of said alloys. Specifically, the invented alloys are designed to undergo a structural transformation from their as-cast state to their final state during and or after annealing, where MC carbides precipitate within the solid solution comprising the alloy during the annealing step 14. In various embodiments, various oxides also precipitate within the solid solution comprising the alloy during the annealing step in addition to the MC carbides. In an embodiment, the invented alloys as-cast are configured to precipitate MC carbides within the solid solution with a BCC structure comprising said alloys when annealed. In an embodiment, the alloys as-cast are also configured to comprise a solid solution with a BCC structure with FCC structured MC carbides distributed therein when annealed.

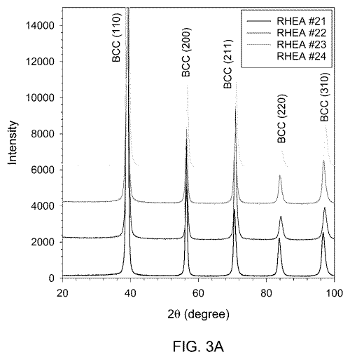

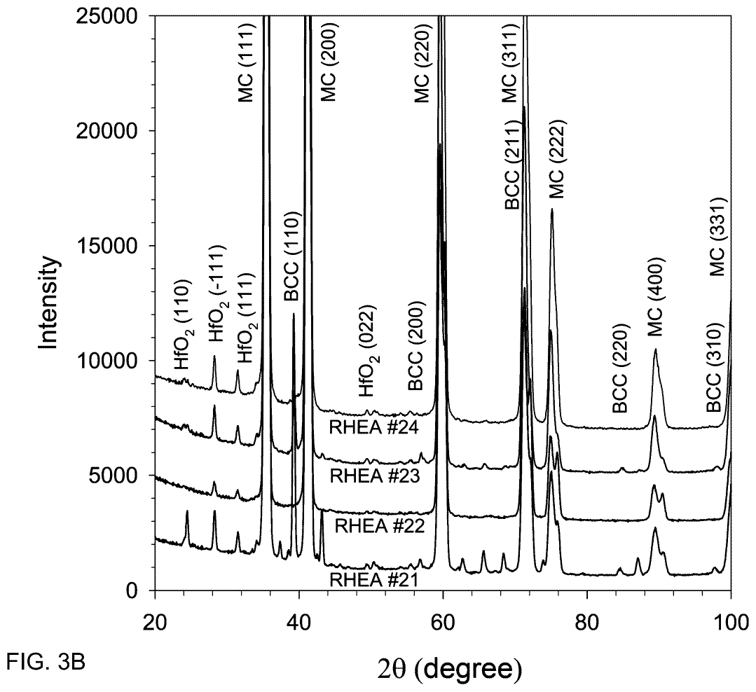

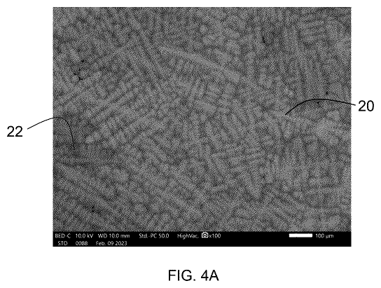

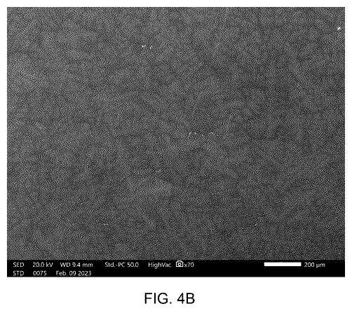

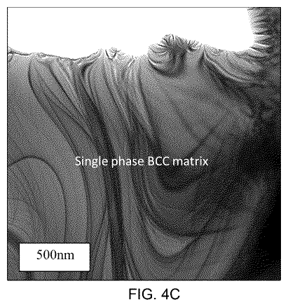

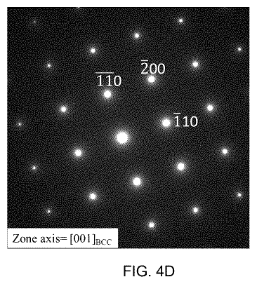

In an embodiment, in the as-cast structure, the alloy is formed (element 12 of FIG. 2) through a non-equilibrium solidification pathway, resulting in a single and/or primarily a single BCC solid solution phase. This is shown in FIG. 3A showing XRD data for as-cast samples of RHEAs 21-24. This is partly due to relatively large cooling rate, and also slow diffusion rate of refractory metals in the solid state. In various embodiments, as-cast alloys comprise inhomogeneous distribution of elements and have a dendric microstructure (element 20 of FIG. 4A), with BCC stabilizing elements with high melting points such as Ta, Mo, W, Nb, and a combination thereof, segregated to dendrite arms, with low-melting-point elements such as Ti, V, Zr, Hf, Al, and C segregated to interdendritic regions (element 22 of FIG. 4A).

In various embodiments, metal carbides are not found in significant quantity in as-cast alloys. In some embodiments, featuring high at % C, the as-cast alloys comprise a small amount of metal carbides. In these embodiments, the as-cast alloys still comprise mainly a single BCC phase as shown in XRD analysis.

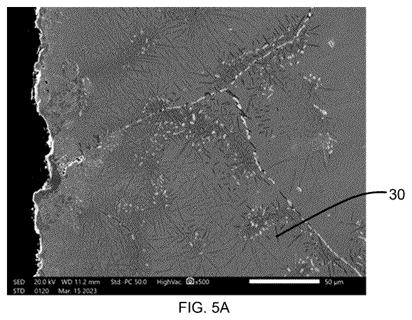

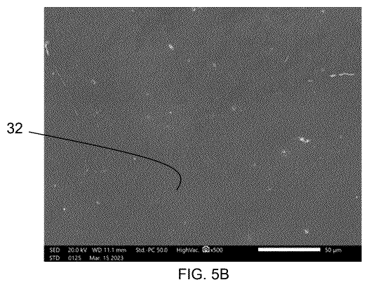

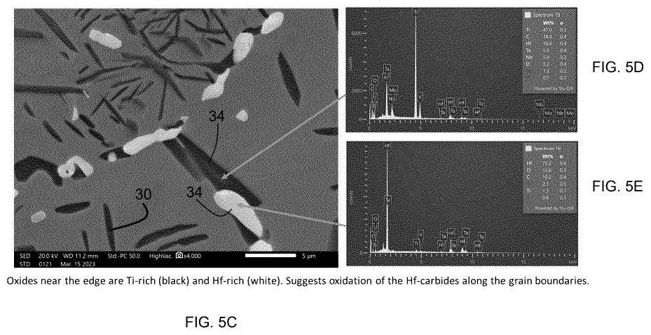

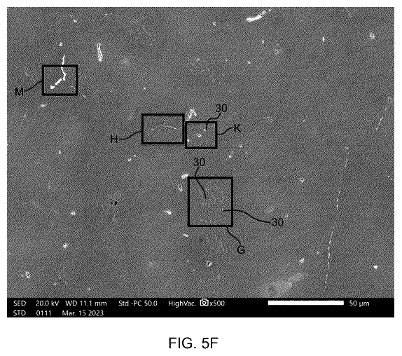

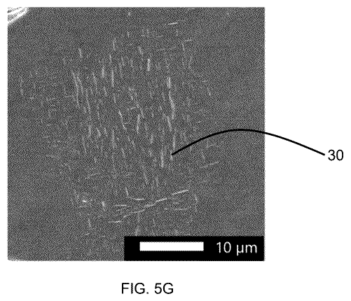

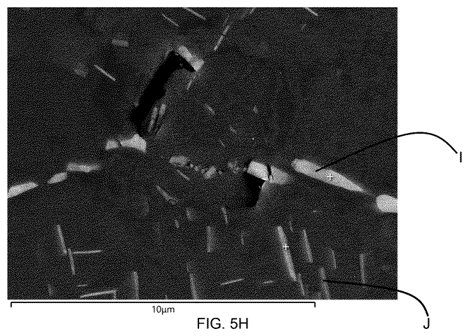

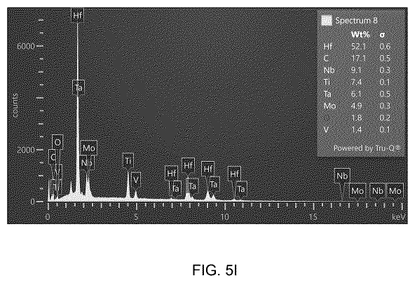

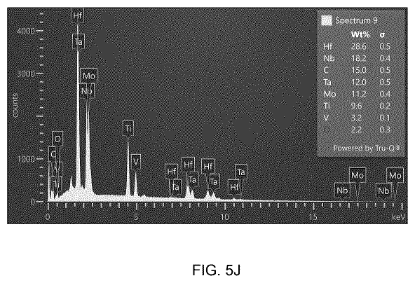

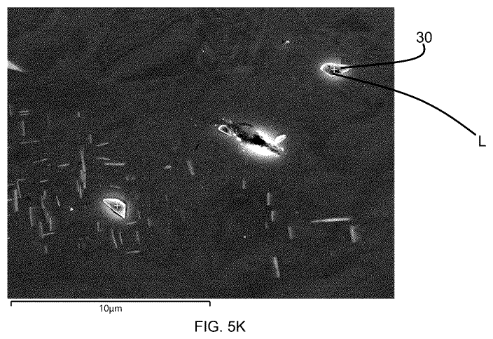

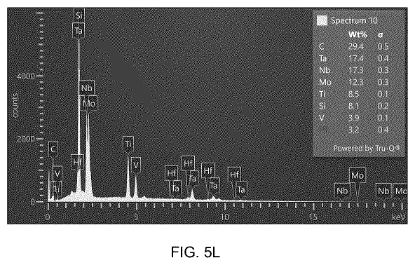

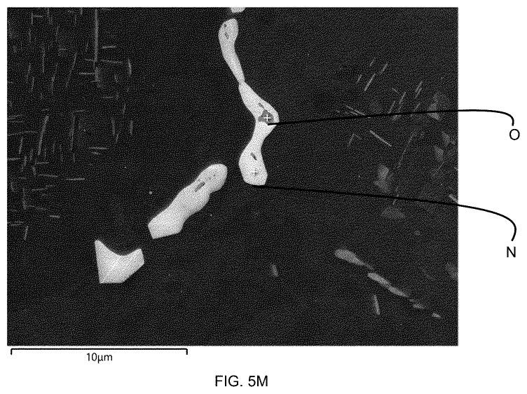

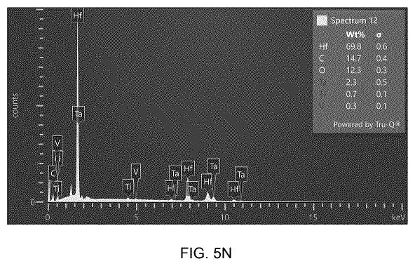

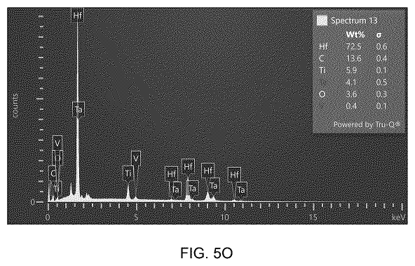

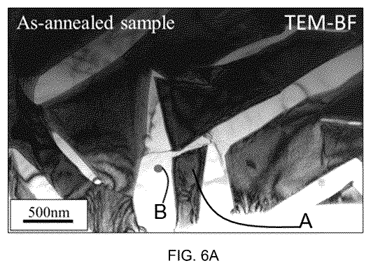

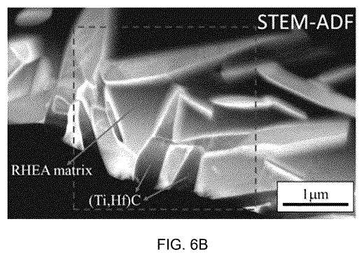

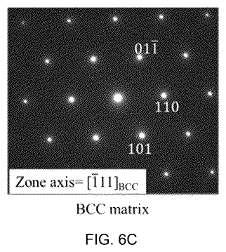

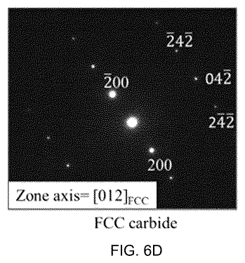

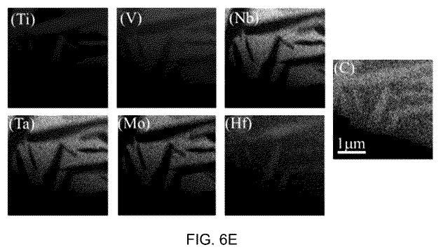

After forming as-cast alloys (element 12 of FIG. 2), those alloys are annealed (element 14 of FIG. 2) to form finalized, precipitate hardened high-performance refractory high entropy alloys. During the annealing step (element 14 of FIG. 2), MC carbides precipitate from the solid solution comprising the alloy. This presence and formation of MC carbide precipitates in the invented high-performance refractory high entropy alloys during the annealing step is a salient feature of the invention. In an embodiment, the annealed alloys comprise an equilibrium matrix BCC phase and a FCC MC carbide phase (shown in FIGS. 6A-D). This is also shown in FIG. 3B showing XRD data for annealed samples of RHEAs 21-24. In embodiments, the annealed alloys comprise MC carbides (element 30 shown in FIGS. 5A, 5C, 5F, 5G, and 5K) in high-density rods or irregular shapes. In embodiments, the alloy comprises a dendritic microstructure (element 32 shown in FIG. 5B), and MC carbides are located at interdendritic regions and grain boundaries. Formation of these MC carbides via precipitation in noticeable amount increases the strength of the annealed alloy versus the as-cast alloy and consequently improves the creep performance of the alloy. Embodiments of the invented high-performance refractory high entropy alloys are crack free. Various embodiments of the invented alloys are fine-grained i.e. comprise grains ranging in size between approximately 1 to approximately 50 μm. In an embodiment, the MC carbides comprise carbides of the elements Ti, Zr, Hf, Nb, Ta, V, and combinations thereof. In an embodiment, said MC carbides are oxidized or partially oxidized.

In an embodiment, the annealed alloys also comprise high entropy alloy matrix and strengthening oxides distributed therein. The oxides (element 34 shown in FIG. 5C) strengthen the invented alloys and comprise oxides of the major elements Ti, Hf, Zr, Y, Ta, Nb, and combinations thereof. FIG. 5C shows Ti-rich oxides as demonstrated the elemental analysis shown in FIG. 5D and Hf-rich oxides as demonstrated by the analysis shown in FIG. 5E.

In an embodiment, the as-cast alloys comprise between approximately 0 mole % and approximately 0.01 mole % MC carbides, wherein the annealed alloys comprise between approximately 0.4 mole % and approximately 5 mole % MC carbides.

A salient feature of the invented high-performance refractory high entropy alloys is their suitability for use in high-temperature applications such as in turbines and turbine blades. The invented high-performance refractory high entropy alloys have properties well suited for such use those properties as a result of the structure of the alloys and that all phases of said alloys are in equilibrium, those properties including: density, solidus temperature, ductility, yield stress, and tensile elongation. As such, the invented alloys are suitable for service temperatures preferably between approximately 25° C. and approximately 2,000° C., more preferably between approximately 800° C. and approximately 2,000° C., and typically between approximately 1,000° C. and approximately 1,800° C. The invented alloys are suitable for use at these service temperatures in either as-cast or annealed conditions.

As a part of the suitability of the invented alloy, in an embodiment, the invented alloy comprises a solidus temperature suitable for the alloy to remain solid during use at elevated temperatures such as described above. In an embodiment, the invented alloys comprise solidus temperatures preferably between approximately 1,800° C. and approximately 2,500° C., more preferably between approximately 2,000° C. and approximately 2,200° C., and typically between approximately 1,500° C. and approximately 2,800° C.

Another salient feature of the invention is its superior yield stress properties at elevated temperatures. In an embodiment, the alloy comprises a yield stress at 1300° C. preferably between approximately 192 MPa and approximately 350 MPa after annealing, more preferably between approximately 400 MPa and approximately 500 MPa, and typically between approximately 100 MPa and approximately 500 MPa.

In an embodiment, the invented high-performance refractory high entropy alloys have a density at 1300° C. suitable for use in turbines, turbine blades, and other applications. In an embodiment, the alloys have a density of less than or equal to 9.0 g/cm³. A person having ordinary skill in the art can readily discern that the density of the invented alloy will vary depending on the composition of the alloy. In an embodiment, the density at room temperature of the invented alloy is preferably between approximately 7.99 g/cm³ and approximately 9.37 g/cm³, more preferably between approximately 8.5 g/cm³ and approximately 9.0 g/cm³, and typically between approximately 8.0 g/cm³ and approximately 9.95 g/cm³.

As described above, the invented alloy is suitable for use in high-temperature applications such as in turbines, specifically in turbine blades. A salient feature of the invention is that the invented alloy possesses the unique ability to maintain its structure and superior properties after producing the alloys and being shaped and or machined into parts for use. Enabling this ability is the superior ductility properties possessed by the invented alloys over prior art alloys. In an embodiment, the invented alloys have a room temperature ductility as measured by compression strain greater than 50%. In an embodiment, the invented alloys have a compression strain preferably between approximately 30% and approximately greater than 50%, and more preferably between approximately 40% and approximately greater than 50%.

Returning to FIG. 2, the forming step 12, comprises creating a mixture comprising the elements to form the as-cast alloy, wherein the mixture comprises said elements in the desired atomic % (at %). In an embodiment, the forming step 12 further comprises solidifying said as-cast alloy along a non-equilibrium pathway. In this embodiment, the annealing step 14 places all phases of the alloy in equilibrium.

### EXAMPLES

As described in this section, as-cast ingots comprise the as-cast alloy formed in the forming step 12 described above and shown in FIG. 2, with annealed or heat-treated samples comprising the high-performance refractory high entropy alloy generated in the annealing step 14 described above and shown in FIG. 2.

Samples of the invented alloys were generated using commercial grade elemental feedstocks, with purity greater than 99.9 wt % by first mixing the desired elements in the desired at %, and then generating an as-cast ingot using arc melting. Said elemental feedstocks were purchased from market vendors such as from Atlantic Equipment Engineers, Inc., headquartered in Upper Saddle River New Jersey. Arc melted samples were produced using a standard arc melting procedure: placing a mixture with the desired at % in an arc melting system, pumping the system to high vacuum overnight and backfilling with argon gas; using titanium sponge to absorb residual oxygen in the chamber; flipping the ingot button between each melting; and repeating the melting process 5-6 times to ensure complete melting; ingot button weigh about 250 grams approximately 4 inch long×1.5 inch wide×0.25 inch thickness. Compositions for the 41 generated sample RHEAs are provided in FIGS. 1A, 1C, 1E, 1G, 1I, and 1K.

Sample ingots were annealed or heat-treated by heating said ingots to 1300° C. for 100 hours under high-purity Argon unless another time is specified.

As-cast ingots of the RHEAs were sectioned, ground, and polished for scanning electron microscopy, transmission electron microscopy, x-ray diffraction, and density measurement. Pin samples were also prepared for compression tests, wherein pin samples were prepared for compression tests using ASTM standard E9-09. Accordingly, prepared pin samples were approximately 5 mm in diameter and 7.5 mm in length, with lateral surfaces in the gage length not varying in diameter more than 1%, machined surfaces having a surface finish of 1.6 μm or better, the ends of the pin samples flat and parallel within 0.0005 mm/mm and perpendicular to the lateral surfaces to within 3′ of arc.

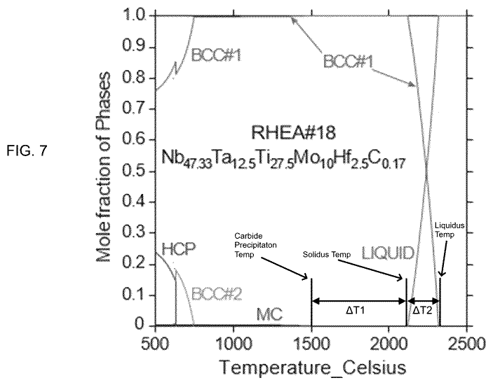

Phase diagrams for alloys were calculated using the CALculation of PHAse Diagram (CALPHAD) method. Said CALPHAD method is described in N. Saunders et al., CALPHAD (calculation of phase diagrams): a comprehensive guide, Pergamon, Oxford, 1998, ISBN 9780080528434, the entirety of which is incorporated by reference herein. FIG. 7 is the calculated phase diagram for RHEA 18. Looking to FIG. 7 demonstrates the calculation of ΔT1 and ΔT2 where ΔT1=Solidus Temperature−Carbide Precipitation Temperature and ΔT2=Liquidus Temperature−Solidus Temperature. These values are reported in the tables of FIGS. 1B, 1D, 1F, 1H, 1J, and 1L. The Scheil Temperature (Scheil T) value reported in FIGS. 1B, 1D, 1F, 1H, 1J, and 1L is the solidus temperature predicted by the model reported in E. Scheil, Remarks on the layer crystal formation, Z. Metallkd. 34 (1942) 70-72, the entirety of which is incorporated by reference herein. The ΔT3 value reported in FIGS. 1B, 1D, 1F, 1H, 1J, and 1L is ΔT3=Liquidus Temperature−Scheil Temperature.

The ductility parameter reported in FIGS. FIGS. 1B, 1D, 1F, 1H, 1J, and 1L was calculated using the model reported in Hu et al., Acta Materialia, 210, 2021, 116800, the entirety of which is incorporated by reference herein.

Yield stress data was calculated using the model reported in Maresca et al., Acta Materialia, 182, 2020, 235, the entirety of which is implemented in a MATLAB code archived by Francesco Maresca et at., Materials Cloud Archive 2021.65 (2021), the entirety of which is incorporated by reference herein. Some key parameters for this model include zero temperature yield stress σ_{y0}, the zero-stress energy barrier for dislocation motion ΔE_{b0}, and the yield stress σ_{y}(T, \dot{∈}) at finite temperature T and strain rate \dot{∈}. This modelling uses EQUATIONS 1-4 below:

$${σ}_{y} ( T , \dot{ϵ} ) = {σ}_{y 0} exp ( - \frac{1}{0.55} \frac{{k}_{B} T}{Δ {E}_{b 0}} ln ( \frac{{\dot{ϵ}}_{0}}{\dot{ϵ}} ) ) , \frac{{σ}_{y}}{{σ}_{y 0}} < 0.5 \qquad EQUATION 1$$

$${σ}_{y} ( T , \dot{ϵ} ) = {σ}_{y 0} \{ 1 - {( \frac{{k}_{B} T}{Δ {E}_{b 0}} ln ( \frac{{\dot{ϵ}}_{0}}{\dot{ϵ}} ) )}^{2 / 3} \} , \frac{{σ}_{y}}{{σ}_{y 0}} \geq 0.5 \qquad EQUATION 2$$

$${σ}_{y 0} = 3.067 {A}_{σ} {a}^{- 1 / 3} {{{G}_{alloy} ( \frac{1 + {v}_{alloy}}{1 - {v}_{alloy}} )}^{4 / 3} [ \frac{{\sum }_{i} {c}_{i} Δ {V}_{i}^{2}}{{b}^{6}} ]}^{2 / 3} \qquad EQUATION 3$$

$$Δ {E}_{b 0} = {A}_{E} {a}^{1 / 3} {G}_{alloy} {{{b}^{3} ( \frac{1 + {v}_{alloy}}{1 - {v}_{alloy}} )}^{2 / 3} [ \frac{{\sum }_{i} {c}_{i} Δ {V}_{i}^{2}}{{b}^{6}} ]}^{2 / 3} \qquad EQUATION 4$$

For EQUATIONS 1-4, v_{alloy}=Poisson's ratio, G_{alloy}=the shear modulus, σ_{y0}=yield stress at T=0K, ΔV=volume misfit, ΔE_{b0}=the zero-stress energy barrier for dislocation motion, cᵢ=the alloy concentration for element i, and σ_{y}(T, \dot{∈})=yield stress at finite temperature and strain rate \dot{∈}.

Room temperature compression strain tests were performed on as-cast samples of the invented alloys using the ASTM E9 Standard Test Methods of Compression Testing of Metallic Materials at Room Temperature using an INSTRON® brand 5900R tensile/compression strength testing machine at a speed of 0.00735 mm/minute at room temperature.

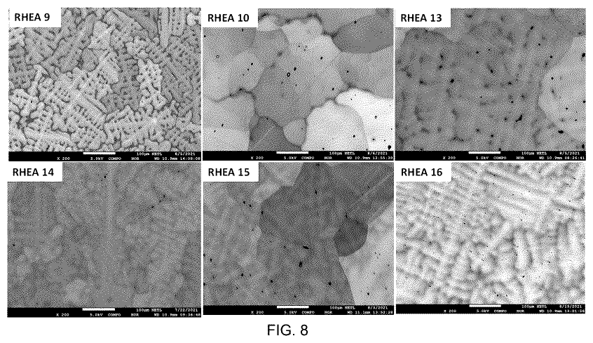

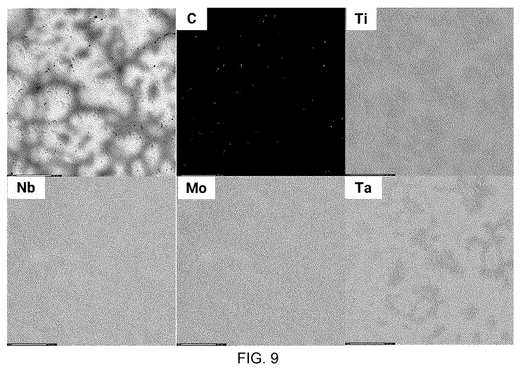

Ingots of RHEAs 9, 10, 13, 14, 15, 16, 17, and 18 were generated and tested according to the procedures described above. XRD indicated that all eight alloys exhibit a single BCC crystal structure. The microstructures of as-cast ingots show a typical dendritic structure except RHEA 10, as shown in backscatter electron (BSE) micrographs in FIG. 8. Compositional mapping results for RHEA 18 shown in FIG. 9 confirms formation of Ti-rich carbides.

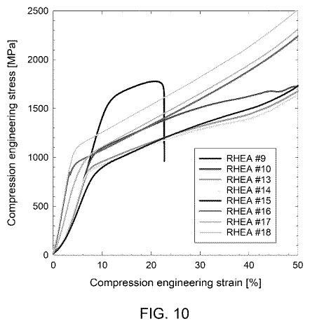

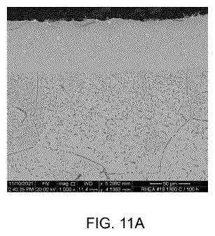

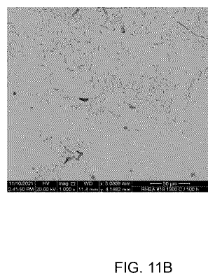

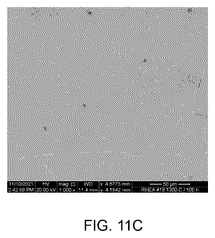

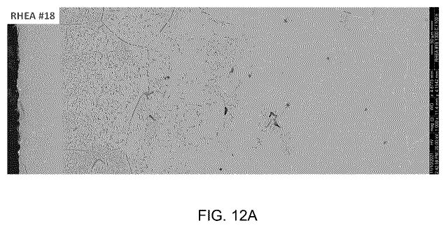

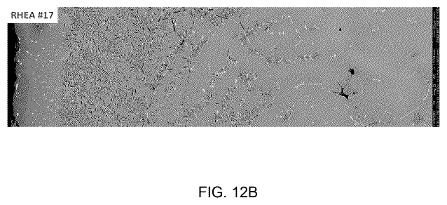

Compression tests were conducted at room temperature on these samples of RHEAs 9, 10, 13, 14, 15, 16, 17, and 18 according to the procedures described above, the results shown in FIG. 10. As shown in FIG. 10, the tested sample of RHEA 9 showed significantly higher yield strength and significantly reduced compression strain, compared to the rest alloys in the batch. This is likely because the sample of RHEA 9 tested for the data in that figure was found to contain impurities from processing including 8.79 at % Cr and 2.31 at % Fe.

Ingots of RHEAs 18, 17, 16, 15, 14, and 1 made using the arc melting procedure described above were annealed, heated to 1300° C. under high-purity Argon for 10 hours, with the resulting microstructures examined using scanning electron microscopy (SEM) and energy dispersive spectroscopy (EDS). FIGS. 11A-C show the backscattered electron (BSE) micrographs of RHEA 18. The surface area is depleted of carbides and forms HfO₂ oxides (white particles). The region immediately below surface region contains concentrated carbides (dark Ti-rich MC carbides and bright Hf-rich MC carbides), and they are distributed along grain boundaries and inside grains as globular or needle morphology. There is also very small amount of HfO₂ particles sparsely distributed, appearing bright and faceted particles. Further into the center of the specimen are Hf-rich particles and HfO₂ particles appearing bright in the micrograph.

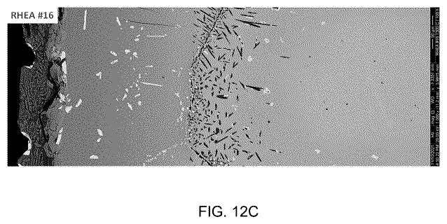

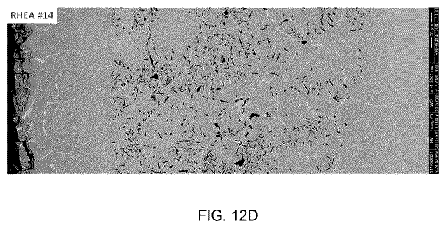

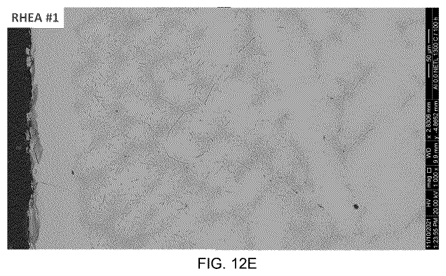

FIGS. 12A-E show the overall microstructure of samples of RHEAs 18, 17, 16, 14, and 1 annealed under high-purity argon at 1300° C. for 100 hours. As shown in these FIGS., the microstructures of RHEA 17, 14, and 18 are very similar. The MC carbides are much finer in RHEA 1 although clustered in inter-dendritic regions and along grain boundaries where segregation of hcp metals (Ti, Hf, Zr) and carbon are favored during solidification partly due to its significantly smaller atomic radius. The non-uniform distribution of carbides in these RHEAs are primarily due to the inhomogeneities in the microstructure (e.g. dendritic vs inter-dendritic) and chemistry distribution. As shown by FIGS. 12A-E, annealing at 1300° C. does not dissolve the microstructure inhomogeneity.

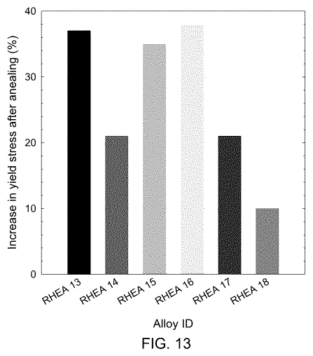

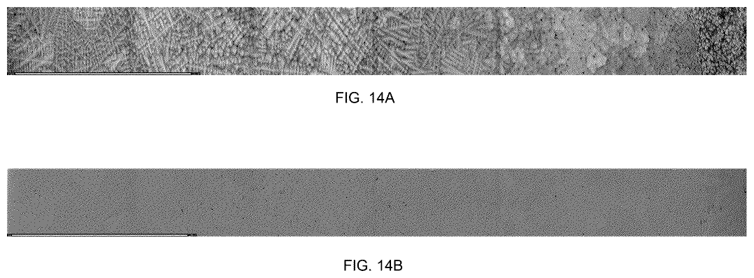

Compression tests were carried out on the samples of RHEAs 18, 17, 16, and 14 alloys at room temperature after annealing the samples at 1300° C. for 100 hours under high-purity argon. Apparent increase in the yield strength is observed compared to before annealing, as shown in FIG. 13. The increase in strength can be due to precipitation strengthening from MC carbides and dispersion strengthening of HfO₂ oxides.

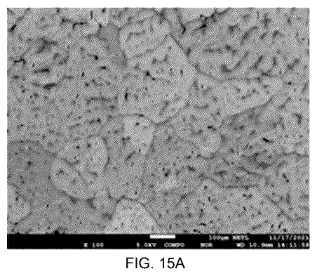

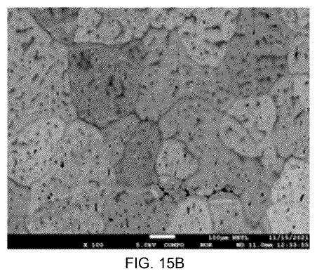

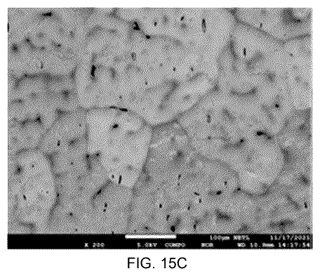

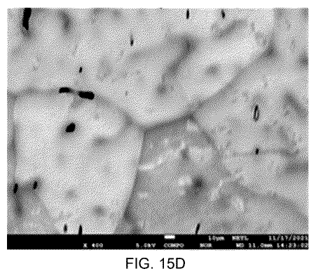

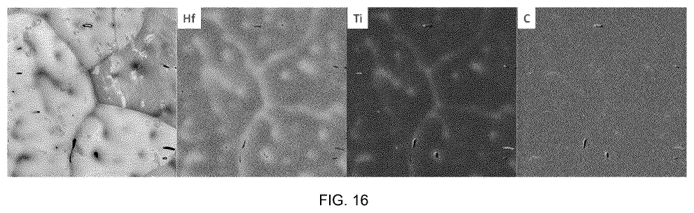

FIGS. 14A and 14B show the microstructure of an as-cast sample of RHEA 19, with FIG. 14A showing a BSE micrograph of a cross-section of RHEA 19 and FIG. 14B showing a SE micrograph of a cross section of RHEA 19. FIGS. 15A-D show BSE micrographs of a cross-section of as-cast RHEA 26 at various magnification. Segregation of Ti and Hf and C in the inter-dendritic regions are confirmed by x-ray composition map are shown in FIG. 16. The chemical segregation is consistent with previously tested RHEAs.

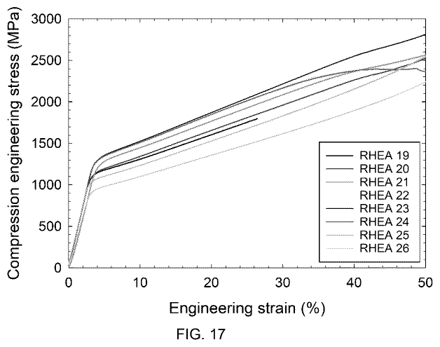

Ingots of RHEAs 19-26 were generated using the arc melting procedure outlined above. Room temperature compression data for these as-cast ingots is shown in FIG. 17. All the alloys are very ductile and did not fracture at 50% compression strain. Note that the test on RHEA 19 was stopped by the operator. The yield strength increases monotonically with increasing Mo contents.

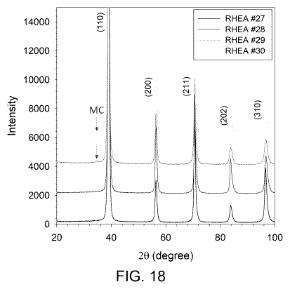

Ingots of RHEAs 27-30 were generated using the arc melting procedure outlined above. X-ray diffraction (XRD) was performed on the as-cast alloys, the results shown in FIG. 18. XRD patterns indicate a dominant BCC phase for all alloys. While no other phases are detected in RHEAs 27 and 28, a small peak that is identified to be FCC MC carbide shows up for RHEAs 29 and 30. This is not surprising as RHEAs 29 and 30 are designed to test the upper limit of carbon contents in relation to the MC precipitation design.

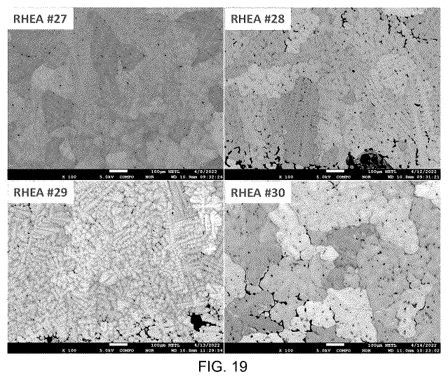

FIG. 19 shows the overall microstructure of the as-cast RHEAs 27-30 observed by scanning electron microscopy (SEM) in the backscatter electron (BSE) mode. All the alloys exhibit typical dendritic microstructure with obvious chemical inhomogeneity.

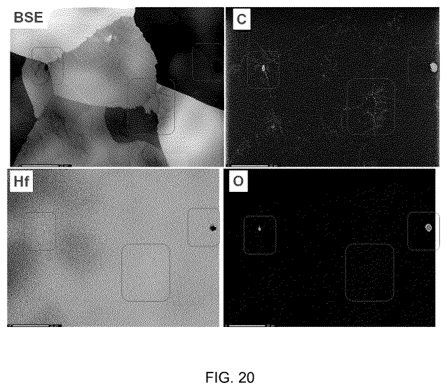

FIG. 20 shows the x-ray wavelength dispersion composition map of RHEA 27 in the as-cast condition. The results indicate formation of (Hf, Zr, Ti)-rich MC carbide along grain boundaries.

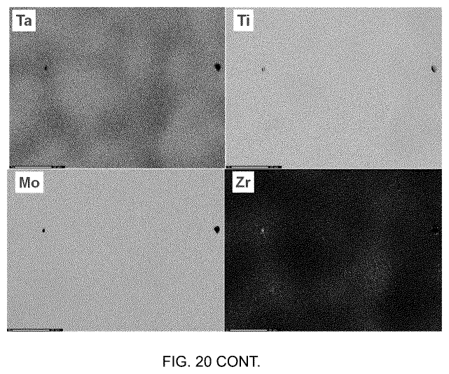

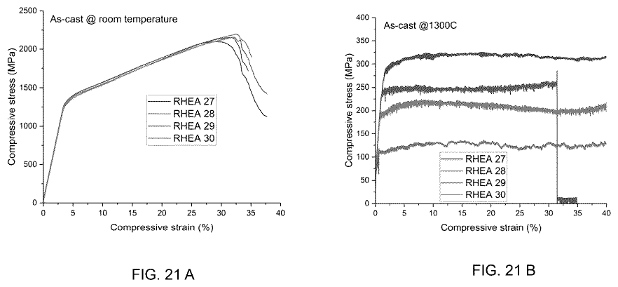

Compression tests were carried out at room temperature on the as-cast ingots of RHEAs 27-30 the results shown in FIG. 21A. Surprisingly, all four alloys behave extremely similar. The as-cast alloys have yield stress 1247-1299 MPa and compression strain 29%-35% at room temperature (see FIG. 1H).

Compression tests were also performed at 1300° C. on the as-cast ingots of RHEAs 27-30, that data shown in FIG. 21B. At 1300° C., all four alloys showed excellent ductility. RHEA 27 showed a yield stress 295 MPa and RHEA 29 showed a yield stress 241 MPa.

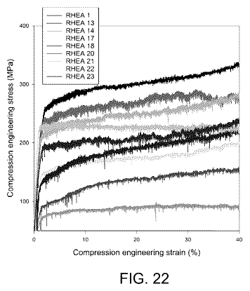

FIG. 22 shows the compression stress strain curves for select RHEA alloys at 1300° C. The alloys were at the as-cast condition. As expected, all the alloys exhibited excellent ductility. The measured yield stress are: 260 MPa for RHEA 1, 90 MPa for RHEA 13, 75 MPa for RHEA 14, 150 MPa for RHEA 17, 135 MPa for RHEA 18, 210 MPa for RHEA 20, 230 MPa for RHEA 21, 226 MPa for RHEA 22, 192 MPa for RHEA 23, respectively.

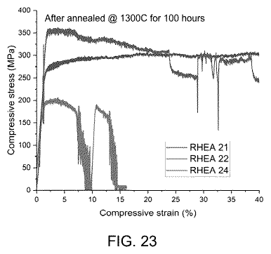

Samples of RHEAs 21, 22, and 24 were annealed at 1300° C. for 100 hours to promote MC precipitation, and then subject to compression tests at 1300° C. The results are shown in FIG. 23. RHEA 24 showed a yield stress of 350 MPa. The yield stress is 270 MPa for RHEA —21, and 192 MPa for RHEA 22. RHEA 21 remains very ductile at 1300° C. Sudden drop in stress was observed in RHEA 22 and RHEA 24. It is not clear whether the sudden drops are due to instrument or defects in the specimens.

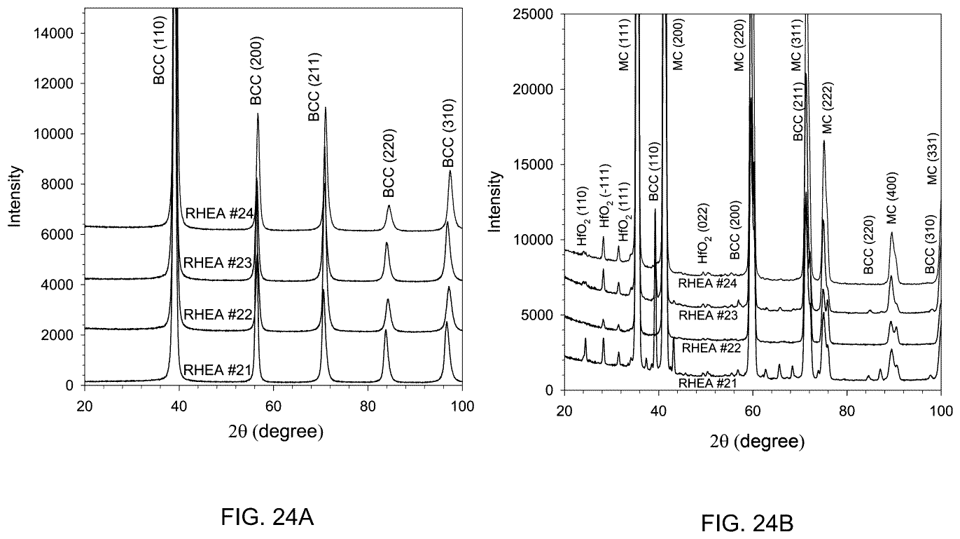

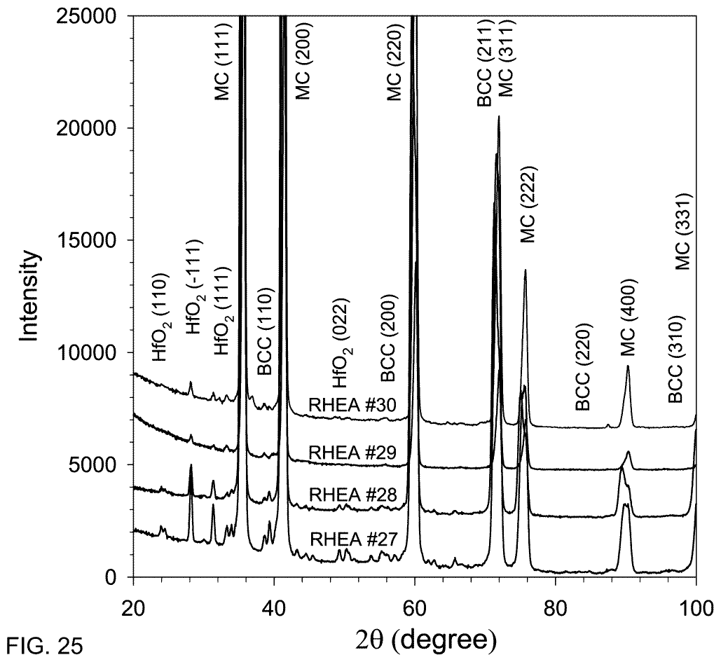

FIGS. 24A-B, FIG. 18, and FIG. 25 compare the X-ray diffraction of exemplary RHEAs in the as-cast condition and after annealed at 1300° C. for 100 hours. Clearly, annealing promotes MC carbide precipitation and HfO₂ oxide formation. Oxygen source can be the oxygen dissolved in the ingots and the oxygen in the chamber even though it is argon protected atmosphere.

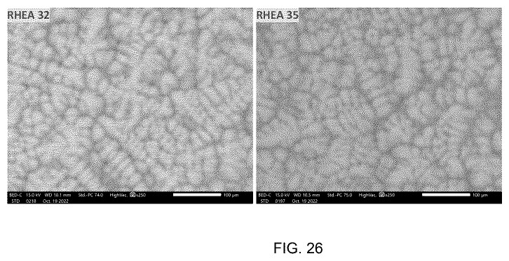

Samples of RHEAs 31-36 were generated according to the arc melting procedure described above. The as-cast RHEA 32 and RHEA 35 exhibit typical dendritic microstructure, as shown in FIG. 26. Chemical segregation is very similar to what was reported for prior numbered RHEAs. That is Ti, Hf, Zr and C are segregated to grain boundaries and interdendritic regions, while Ta and Mo tend to segregate to dendrite arms.

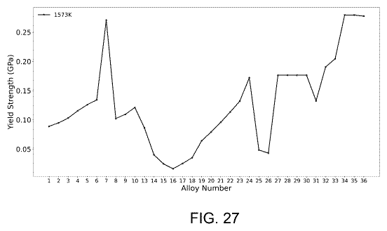

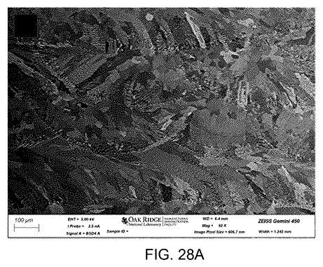

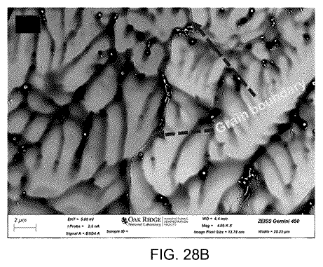

The predicted yield stress of RHEAs 1-36 are shown in FIG. 27 The predicted yield stresses qualitatively agree with experimental results.

An industrial scale, 20 kg ingot of RHEA 32 was generated using plasma arc melting. As expected in the as cast condition a dendritic structure formed. Similar to the small 250-gram arc melted samples, in the as cast condition the alloy was primarily BCC, with a few small carbide precipitates. Casting defects such as small pores were also detected. The microstructure in the heat-treated condition was also very similar to the small arc melted samples. Carbides and Hf-oxides formed along grain boundaries and with the grains at the surface. Fine Ti—Hf carbides formed in the interior of the samples. Mo—Ta—Nb carbides were also observed. Oxidized Hf carbides were also observed along grain boundaries.

The microstructure of the industrial scale ingot was characterized by scanning electron microscopy (SEM) and transmission electron microscopy (TEM) in both the as-cast and annealed condition (1300° C.-100 h).

In the as as-cast condition the alloy showed a dendritic structure (FIGS. 4A and 4B). The microstructure contained small pores which are likely from solidification. Very fine Hf/Ti carbides were observed in the SEM (FIG. 4B). TEM showed the as-cast alloy was single phase body centered cubic structure (BCC), consistent with previous analyses on small arc-melted buttons (FIGS. 5A and 5B). In the heat-treated condition, Ti and Hf oxides precipitates formed inside and along grain boundaries (FIGS. 5C, 5D, and 5E) at the surface of the heat-treated sample. The interior of the sample was devoid of the surface precipitates (FIG. 5B). The interior of the heat-treated sample contained dense regions of Hf carbides as well as larger Hf-carbides along the grain boundaries which were oxidized (FIGS. 5E-5L). Ta/Nb/Mo carbides were also observed in the interior (FIGS. 5F and FIGS. 5M-0). TEM analysis also showed the precipitation of fine Ti/Hf carbides in the matrix (FIGS. 6A-6E).

Samples of RHEA 15 were also generated using a laser directed energy deposition (L-DED process) using gas-atomized feedstock powders purchased from Retech Systems, LLC headquartered in Buffalo New York. The L-DED process was carried out in a inerted chamber at room temperature using laser power of 600 W and beam speeds ranging 1,500-1,800 mm/minute. The RHEA material was built upon a niobium substrate. Scan strategies of 67-90 degree interlayer rotations and circular patterns were used.

Three rounds of L-DED of RHEA 15 were performed with the L-DED parameters for each round reported in TABLE 1 below.

TABLE 1

| Build | | P | V | | | | Heated |
|---|---|---|---|---|---|---|---|
| round | | (% of | (mm/ | Layer | Hatch | Scan | sub- |
| # | Dimensions | 2 kW) | min) | (mm) | (mm) | strategy | strate |
| Round | 10 × 10 × 10 | 600 W | 1800 | 0.15 | 0.4 | 90° | N |
| #1 | mm³ (set 8) | (30%) | | | | interlayer | |
| | 10 × 10 × 10 | 600 W | 1500 | 0.15 | 0.4 | 90° | N |
| | mm³ (set 10) | (30%) | | | | interlayer | |
| | 10 × 10 × 10 | 600 W | 1800 | 0.20 | 0.4 | 90° | N |
| | mm³ (set 11) | (30%) | | | | interlayer | |
| | 10 × 10 × 10 | 600 W | 1500 | 0.20 | 0.4 | 90° | N |
| | mm³ (set 12) | (30%) | | | | interlayer | |
| Round | 10 × 10 × 10 | 600 W | 1500 | 0.20 | 0.4 | 90° | Y |
| #2 | mm³ | (30%) | | | | interlayer | |
| | 10 × 10 × 10 | 600 W | 1500 | 0.20 | 0.4 | 67° | Y |
| | mm³ | (30%) | | | | interlayer | |
| Round | Cylinder | 600 W | 1500 | 0.20 | 0.4 | Circular | Y |
| #3 | ϕ 12.5 mm | (30%) | | | | | (laser) |

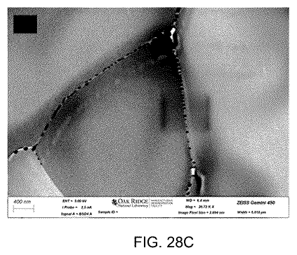

Microstructural characterization of a sample of RHEA 15 generated during round 2 of L-DED manufacturing was carried out. Results of that testing are shown in the BSE micrographs of FIGS. 28A-28C. FIG. 28A shows a back scattered electron (BSE) micrograph acquired from an as-built RHEA 15 specimen with 67° interlayer rotation. Dendritic microstructure was prominent in the specimen. A higher magnification BSE image is shown in FIG. 28B with high and low angle grain boundaries. Grain boundaries were mostly ‘decorated’ with nanoscale precipitates that may be either carbides or oxides. FIG. 28C shows a very high magnification BSE image with grain triple junction grain boundaries. The nanoscale precipitates are of the order of tens of nanometers and may advantageously lead to boundary drag at elevated temperatures.

Samples of RHEA 15 were also generated using an electron beam melting (EBM) additive manufacturing process using the same atomized feedstocks used in the L-DED process. The EBM process was carried out with build temperatures in excess of 1200 C and beam speeds ranging 300-500 mm/sec and beam currents 12-18 mA. The RHEA material was built upon a niobium substrate using a 90 degree bi-direction interlayer scan strategy.

The primary parameters for the EBM process used to make samples of RHEA 15 are reported in TABLE 2 below, with build parameters used for nine rounds of building presented in TABLE 3 below.

TABLE 2

| EBM | | | | | | | |
|---|---|---|---|---|---|---|---|
| Build | | Beam | V | | | | Substrate |
| round | Dimen- | current | (mm/ | Layer | Hatch | Scan | temper- |
| # | sions | (mA) | s) | (mm) | (mm) | strategy | ature |
| Round | 15 × 15 × | 15-18 | 300 | 0.20 | 0.05- | Bi- | 1300° C. |
| #1 | 3.5 | | | | 0.10 | directional/ | |
| | mm³ | | | | | 90 degree | |
| | | | | | | interlayer | |

TABLE 3

| | Beam | Beam | Hatch | layer | Beam | |
|---|---|---|---|---|---|---|
| | current | speed | spacing | thickness | power | |
| Build # | (mA) | (mm/s) | (mm) | (mm) | (W) | VED |
| 1 | 12 | 300 | 0.075 | 0.2 | 720 | 160 |
| 2 | 12 | 400 | 0.1 | 0.2 | 720 | 90 |
| 3 | 12 | 500 | 0.125 | 0.2 | 720 | 57.6 |
| 4 | 15 | 300 | 0.1 | 0.2 | 900 | 150 |
| 5 | 15 | 400 | 0.125 | 0.2 | 900 | 90 |
| 6 | 15 | 500 | 0.075 | 0.2 | 900 | 120 |
| 7 | 18 | 300 | 0.125 | 0.2 | 1080 | 144 |
| 8 | 18 | 400 | 0.075 | 0.2 | 1080 | 180 |
| 9 | 18 | 500 | 0.1 | 0.2 | 1080 | 108 |

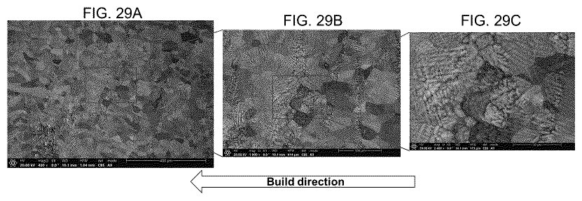

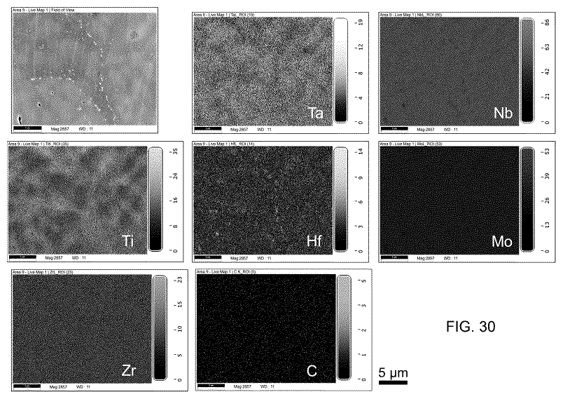

This EBM processing provided crack and defect-free samples of RHEA 15. FIGS. 29A-C shows the microstructure of the EBM generated sample of RHEA 15 from build #5 described in TABLE 3. A coarser dendritic microstructure is evident as compared to the microstructure of the L-DED processed alloy. High preheat temperature in EBM minimizes thermal gradients and cooling rates as compared to low preheat temperature in L-DED. Consequently, the thermal strains and strain rates are low in EBM. Low cooling rates and thermal gradients increase the propensity for formation of coarse equiaxed dendritic microstructure. A similar elemental distribution is revealed as was with the L-DED processed alloy, the elemental distribution for the EBM sample showed in FIG. 30. The EBM processing occurs at a closer-to-equilibrium thermos-kinetics as compared to L-DED. Immiscibility gap between Group-IV and Group-V elements is evident in the EDS maps. Group V elements concentrated in dendritic arms, whereas Group-IV elements are concentrated in the inter-dendritic region. Lighter second phase particles are Hf—, O- and C-rich; oxides of Hf and Ti.

In an embodiment, the invention provides a high-performance refractory high entropy alloy comprising: Nb≥30 at %, Ta≤20 at %, Ti≤30 at %, Mo≤30 at %, Hf≤5 at %, Zr≤5 at %, C≤5 at %, V≤20 at %, Al between approximately 0 and approximately 10 at %, Cr between approximately 0 and approximately 10 at %, W≤10 at %, B≤1 at %, and Y≤1 at %. In embodiments, the high-performance refractory high entropy alloy of comprises a solid solution with a BCC structure. In embodiments, the high-performance refractory high entropy alloy of the alloy is configured to precipitate MC carbides within the solid solution with a BCC structure when annealed. In embodiments, the high-performance refractory high entropy alloy is configured to precipitate MC carbides with a threshold precipitation temperature greater than 1300° C. In embodiments the high-performance refractory high entropy alloy is configured to comprise a solid solution with a BCC structure with FCC structured MC carbides distributed therein when annealed. In embodiments, the MC carbides are carbides of elements selected from Ti, Zr, Hf, and combinations thereof. In embodiments, the high-performance refractory entropy alloy of the MC carbides are positioned in interdendritic regions of the solid solution and on grain boundaries of said alloy. In embodiments, the alloy is configured to further comprise oxides of elements selected from Ti, Zr, Hf, and combinations thereof when annealed.

In an embodiment, the invention provides a method for producing a high-performance refractory entropy alloy comprising: forming an as-cast alloy comprising Nb≥30 at %, Ta≤20 at %, Ti≤30 at %, Mo≤30 at %, Hf≤5 at %, Zr≤5 at %, C≤5 at %, V≤20 at %, Al between approximately 0 and approximately 10 at %, Cr between approximately 0 and approximately 10 at %, W≤10 at %, B≤1 at %, and Y≤1 at %; annealing the as-cast alloy to form a high-performance refractory high entropy alloy. In embodiments, MC carbides precipitate within the alloy during the annealing step. In embodiments, the MC carbides are carbides of elements selected from Ti, Zr, Hf, Nb, Ta, V, and combinations thereof. In embodiments, oxides of the elements selected from Zr, Hf, and combinations thereof precipitate in the alloy during the annealing step. In embodiments, the as-cast alloy comprises a single BCC phase. In embodiments, the high-performance refractory high entropy alloy comprises a BCC phase with the MC carbides in a FCC phase within said BCC phase. In embodiments, the high-performance refractory high entropy alloy comprises a yield strength of between approximately 75 MPa and approximately 500 MPa at 1300° C. In embodiments, forming the as-cast alloy comprises a non-equilibrium solidification pathway. In embodiments, the annealing step places all phases of the high-performance refractory high entropy alloy in equilibrium.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially, and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The terms “about” and “approximately” generally refer to a range of numbers that one of skill in the art would consider equivalent to the recited value (e.g., having the same function or result). In many instances, the terms “about” and “approximately” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A high-performance refractory high entropy alloy comprising:
Nb≥30 at %, Ta≤20 at %, Ti≤30 at %, Mo≤30 at %, Hf≤5 at %, Zr≤5 at %, C≤5 at %, V≤20 at %, Al between approximately 0 and approximately 10 at %, Cr between approximately 0 and approximately 10 at %, W≤10 at %, B≤1 at %, and Y≤1 at %.

2. The high-performance refractory high entropy alloy of claim 1 wherein the alloy comprises a solid solution with a BCC structure.

3. The high-performance refractory high entropy alloy of claim 2 wherein the alloy is configured to precipitate MC carbides within the solid solution with a BCC structure when annealed.

4. The high-performance refractory high entropy alloy of claim 3 wherein the alloy is configured to precipitate MC carbides with a threshold precipitation temperature greater than 1300° C.

5. The high-performance refractory high entropy alloy of claim 3 wherein the alloy is configured to comprise a solid solution with a BCC structure with FCC structured MC carbides distributed therein when annealed.

6. The high-performance refractory high entropy alloys of claim 3 wherein the MC carbides are carbides of elements selected from Ti, Zr, Hf, and combinations thereof.

7. The high-performance refractory entropy alloy of claim 3 wherein the MC carbides are positioned in interdendritic regions of the solid solution and on grain boundaries of said alloy.

8. The high-performance refractory entropy alloy of claim 3 wherein the alloy is configured to further comprise oxides of elements selected from Ti, Zr, Hf, and combinations thereof when annealed.

9. A method for producing a high-performance refractory entropy alloy comprising:
forming an as-cast alloy comprising Nb≥30 at %, Ta≤20 at %, Ti≤30 at %, Mo≤30 at %, Hf≤5 at %, Zr≤5 at %, C≤5 at %, V≤20 at %, Al between approximately 0 and approximately 10 at %, Cr between approximately 0 and approximately 10 at %, W≤10 at %, B≤1 at %, and Y≤1 at %; and
annealing the as-cast alloy to form a high-performance refractory high entropy alloy.

10. The method of claim 9 wherein MC carbides precipitate within the alloy during the annealing step.

11. The method of claim 10 wherein the MC carbides are carbides of elements selected from Ti, Zr, Hf, Nb, Ta, V, and combinations thereof.

12. The method of claim 10 wherein oxides of the elements selected from Zr, Hf, and combinations thereof precipitate in the alloy during the annealing step.

13. The method of claim 10 wherein the as-cast alloy comprises a single BCC phase.

14. The method of claim 13 wherein the high-performance refractory high entropy alloy comprises a BCC phase with the MC carbides in a FCC phase within said BCC phase.

15. The method of claim 10 wherein the high-performance refractory high entropy alloy comprises a yield strength of between approximately 75 MPa and approximately 500 MPa at 1300° C.

16. The method of claim 10 wherein forming the as-cast alloy comprises a non-equilibrium solidification pathway.

17. The method of claim 16 wherein the annealing step places all phases of the high-performance refractory high entropy alloy in equilibrium.
